(19) United States
(12) Patent Application Publication
(10) Pub. No.: US 2023/0076808 A1
(43) Pub. Date: Mar. 9, 2023

(54) MODULAR CONNECTOR SYSTEM CONFIGURED FOR SETTING VERTICAL OR HORIZONTAL PIPING OR PREFAB ASSEMBLIES IN PLACE PRIOR TO WALL CONSTRUCTION

(71) Applicants: Edward L. Nicks, III, Chapin, SC (US); James W. Gable, JR., Irmo, SC (US); Justin J. Gable, Chapin, SC (US)

(72) Inventors: Edward L. Nicks, III, Chapin, SC (US); James W. Gable, JR., Irmo, SC (US); Justin J. Gable, Chapin, SC (US)

(21) Appl. No.: 17/929,583

(22) Filed: Sep. 2, 2022

Related U.S. Application Data
(60) Provisional application No. 63/240,903, filed on Sep. 4, 2021.

(51) Int. Cl. F16L 41/10; F16L 41/12; F16L 41/08

(52) U.S. Cl. CPC F16L 41/10; F16L 41/12; F16L 41/086

(57) ABSTRACT

A modular connector system is designed and configured for setting various building material members in place prior to construction of a wall. The modular connector system includes a base plate, a vertical riser member, at least one horizontal arm, and a connection member for each of the at least one horizontal arms. The base plate is configured to support the modular connector system. The vertical riser member is affixed to the base plate in a vertical orientation. Each of the at least one horizontal arm is configured to be adjustably positioned along the vertical riser member. The connection member on each of the horizontal arms is configured to attach to one of the building material members. Wherein, the disclosed modular connector system is designed and configured for setting the building material members in place prior to construction of the wall.

### CROSS-REFERENCE TO RELATED APPLICATIONS

This application claims benefit to U.S. Provisional Patent Application No. 63/240,903 filed on Sep. 4, 2021, entitled “MODULAR CONNECTOR SYSTEM CONFIGURED FOR SETTING VERTICAL OR HORIZONTAL PIPING OR PREFAB ASSEMBLIES IN PLACE PRIOR TO WALL CONSTRUCTION”, which is incorporated by reference in its entirety.

### FIELD OF THE DISCLOSURE

The present disclosure relates to building and construction of residential and/or commercial structures. More specifically, the present disclosure is directed toward a modular connector system configured for setting vertical or horizontal piping, or prefab assemblies in place prior to wall construction.

### BACKGROUND

Generally speaking, construction is a general term meaning the art and science to form objects, systems, or organizations. To construct is the verb: the act of building, and the noun is construction: how something is built, the nature of its structure. In its most widely used context, construction covers the processes involved in delivering buildings, infrastructure, industrial facilities and associated activities through to the end of their life. It typically starts with planning, financing, and design, and continues until the asset is built and ready for use. Building construction is the process of adding structures to areas of land, also known as real property sites.

Construction may be undertaken by individual land-owners (self-build), by specialist house-builders, by property developers, by general contractors, or by providers of public or social housing. Construction practices, technologies, and resources must conform to local building authority regulations and codes of practice. Materials readily available in the area generally dictate the construction materials used (e.g.: brick versus stone versus timber). Costs of construction on a per square meter (or per square foot) basis for building structures can vary dramatically based on site conditions, access routes, local regulations, economies of scale (custom-designed homes are often more expensive to build) and the availability of skilled tradespeople.

Depending upon the type of building, non-residential building construction can be procured by a wide range of private and public organizations. Most construction in these sectors is undertaken by general contractors.

The purposes of walls in buildings are to support roofs, floors and ceilings; to enclose a space as part of the building envelope along with a roof to give buildings form; and to provide shelter and security. In addition, the wall may house various types of utilities such as electrical wiring or plumbing.

The instant disclosure recognizes the problem, difficulty, expense, and man power associated with setting the building material for such utilities, including electrical, wiring, or plumbing. These problems include the difficulty and man power required to hold pipe, sleeve material, duct, etc. during the construction process of the wall, which either requires multiple individuals to set and hold the building materials for such utilities in place while the wall is constructed. Or it requires the wall to be partially disassembled to add the building materials for such utilities after the wall is assembled. Clearly there is a need to provide new means and/or method to set and install such building materials for utilities in walls that require less man power, are easier, quicker and less expensive to use.

The disclosure may be designed to address at least certain aspects of the problems noted above with available construction materials and methods for setting building material for utilities in walls by providing the disclosed modular connector system configured for setting vertical or horizontal piping, or prefab assemblies in place prior to wall construction.

### SUMMARY

The present disclosure may solve the aforementioned limitations of the currently available construction materials and methods for setting building material for utilities in walls by providing a modular connector system. The disclosed modular connector system may be designed and/or configured for setting various building material members in place prior to construction of a wall. The modular connector system may generally include a base plate, a vertical riser member, at least one horizontal arm, and a connection member for each of the at least one horizontal arms. The base plate may be configured to support the modular connector system. The vertical riser member may be affixed to the base plate in a vertical orientation. Each of the at least one horizontal arm may be configured to be adjustably positioned along the vertical riser member. The connection member on each of the horizontal arms may be configured to attach to one of the building material members. Wherein, the disclosed modular connector system may be designed and/or configured for setting the building material members in place prior to construction of the wall. As an example, and clearly not limited thereto, when the building material members are vertical piping, horizontal piping, or prefab assemblies, the modular connector system may be designed and/or configured for setting the vertical piping, the horizontal piping or the prefab assemblies in place prior to construction of the wall.

One feature of the disclosed modular connector system may be that the vertical riser member can include an adjustable height. In select embodiments, the vertical riser member may include an outer tube riser member and an inner tube riser member. The outer tube riser member may be affixed to the base plate. The inner tube riser member may be telescopically engaged with the outer tube riser member (or vice versa). Wherein, the adjustable height of the vertical riser member may be configured to be lengthened by telescopically extending the inner tube riser member from the outer tube riser member. And in reverse, the adjustable height of the vertical riser member may be configured to be shortened by telescopically retracting the inner tube riser member into the outer tube riser member.

Another feature of the disclosed modular connector system may be that the adjustable height of the vertical riser member may be configured to be locked into a desired length via a length locking mechanism. In select embodiments, the length locking mechanism may include a threaded length locking portion, an inner tube engaging end, and a length locking T-handle portion end. The threaded length locking portion may be threadedly engaged through a threaded length locking hole in the outer tube riser member. The inner tube engaging end may be on an inner end of the threaded length locking portion. The inner tube engaging end may be configured to engage the inner tube riser member inside of the outer tube riser member. The length locking T-handle portion end may be on an outer end of the threaded length locking portion. The length locking T-handle portion end may be configured to be manipulated for rotating the threaded length locking portion. Wherein, the length locking mechanism may be configured to securely position the inner tube riser member at the desired length about the outer tube riser member by rotating the threaded length locking portion engaged in the threaded length locking hole in the outer tube riser member via the length locking T-handle portion end, thereby, engaging and disengaging the inner tube engaging end against the inner tube riser member. In select embodiments of the disclosed modular connector system, the length locking mechanism may further include a second threaded length locking portion, a second inner tube engaging end, and a second length locking T-handle portion end. The second threaded length locking portion may be threadedly engaged through a second threaded length locking hole in the outer tube riser member. The second inner tube engaging end may be on a second inner end of the second threaded length locking portion. The second inner tube engaging end may be configured to engage the inner tube riser member inside of the outer tube riser member. The second length locking T-handle portion end may be on a second outer end of the second threaded length locking portion. The second length locking T-handle portion end may be configured to be manipulated for rotating the second threaded length locking portion. Wherein, the length locking mechanism may be configured to securely position the inner tube riser member at the desired length about the outer tube riser member by rotating the second threaded length locking portion engaged in the second threaded length locking hole in the outer tube riser member via the second length locking T-handle portion end, thereby, engaging and disengaging the second inner tube engaging end against the inner tube riser member.

Another feature of the disclosed modular connector system may be that the base plate can be configured to be leveled. In select embodiments, the base plate may include at least one independent leveling foot configured for leveling the base plate. In select possibly preferred embodiments, the base plate may include four independent leveling feet. Each of the four independent leveling feet may be configured for independently leveling the base plate. Each of the four independent leveling feet may be positioned approximate a corner of a rectangular shape of the base plate. In select embodiments, each of the at least one independent leveling feet may include a threaded leveling portion, a bottom surface engaging end, and a leveling T-handle portion end. The threaded leveling portion may be threadedly engaged through a threaded leveling hole in the base plate. The bottom surface engaging end may be on a bottom end of the threaded leveling portion. The bottom surface engaging end may be configured to engage a surface below a bottom side of the base plate. The leveling T-handle portion end may be on a top end of the threaded leveling portion. The leveling T-handle portion end may be configured to be manipulated for rotating the threaded leveling portion. Wherein, each of the at least one independent leveling foot may be configured to level the base plate by rotating the threaded leveling portion engaged in the threaded leveling hole in the base plate via the leveling T-handle portion end, thereby, raising or lowering the bottom surface engaging end.

Another feature of the disclosed modular connector system may be the inclusion of at least one vertical to horizontal transfer knuckle. Each of the at least one horizontal arm may be configured to be adjustably positioned along the vertical riser member via one of the at least one vertical to horizontal transfer knuckles. In select embodiments, each of the at least one vertical to horizontal transfer knuckles may include a vertical tube portion and a horizontal tube portion. The vertical tube portion may be positioned along the vertical riser member. The vertical tube portion includes a first knuckle adjustment mechanism configured to securely position the vertical tube portion at a desired height and a desired radial orientation about the vertical riser member. The horizontal tube portion may be secured to the vertical tube portion in a horizontal orientation. The horizontal tube portion may include a second knuckle adjustment mechanism configured to securely position one of the at least one horizontal arms at a desired depth about the vertical riser member. Wherein, each of the at least one vertical to horizontal transfer knuckles may be configured to orient one of the at least one horizontal arms at the desired height, the desired radial orientation, and the desired depth about the vertical riser member. In select embodiments, the first knuckle adjustment mechanism may include a first knuckle threaded portion, a vertical riser engaging end, and a first knuckle T-handle portion end. The first knuckle threaded portion may be threadedly engaged through a first knuckle threaded hole in the vertical tube portion. The vertical riser engaging end may be on a first distal end of the first knuckle threaded portion. The vertical riser engaging end may be configured to engage the vertical riser member inside of the vertical tube portion. The first knuckle T-handle portion end may be on a first proximal end of the first knuckle threaded portion. The first knuckle T-handle portion end may be configured to be manipulated for rotating the first knuckle threaded portion. Wherein, the first knuckle adjustment mechanism may be configured to securely position the vertical tube portion at the desired height and the desired radial orientation about the vertical riser member by rotating the first knuckle threaded portion engaged in the first knuckle threaded hole in the vertical tube portion via the first knuckle T-handle portion end, thereby, engaging and disengaging the vertical riser engaging end against the vertical riser member. In other select embodiments, the second knuckle adjustment mechanism may include a second knuckle threaded portion, a horizontal arm engaging end, and a second knuckle T-handle portion end. The second knuckle threaded portion may be threadedly engaged through a second knuckle threaded hole in the horizontal tube portion. The horizontal arm engaging end may be on a second distal end of the second knuckle threaded portion. The horizontal arm engaging end may be configured to engage the horizontal arm inside of the horizontal tube portion. The second knuckle T-handle portion end may be on a second proximal end of the second knuckle threaded portion. The second knuckle T-handle portion end may be configured to be manipulated for rotating the second knuckle threaded portion. Wherein, the second knuckle adjustment mechanism may be configured to securely position the horizontal arm inside of the horizontal tube portion at the desired depth about the vertical riser member by rotating the second knuckle threaded portion engaged in the second knuckle threaded hole in the horizontal tube portion via the second knuckle T-handle portion end, thereby, engaging and disengaging the horizontal arm engaging end against the horizontal arm.

Another feature of the disclosed modular connector system may be that the connection member of each of the at least one horizontal arm may include an adjustable building material clamp and/or an adjustable horizontal support. The adjustable building material clamp may be removably attached to the horizontal arm. The adjustable horizontal support may also be removably attached to the horizontal arm. The adjustable horizontal support may be configured for leveling the modular connector system by applying force to the wall or a fixed support. In select embodiments of the disclosed modular connector system, the adjustable building material clamp may be configured for attaching to vertical piping, horizontal piping, or prefab assemblies. In other select embodiments of the disclosed modular connector system, the adjustable horizontal support may include a support member configured to engage the wall or the fixed support for leveling the modular connector system. In other select embodiments, each of the at least one horizontal arm may include a first threaded connection point and the adjustable building material clamp and/or the adjustable horizontal support may include a second threaded connection point affixed thereto. Wherein, the adjustable building material clamp or the adjustable horizontal support may be configured to be removably connected to one of the at least one horizontal arms by threadedly engaging the second threaded connection point affixed to the adjustable building material clamp or the adjustable horizontal support onto the first threaded connection point on the horizontal arm.

In another aspect, the instant disclosure embraces the modular connector system in any embodiment and/or combination of embodiments shown and/or described herein.

In another aspect, the instant disclosure embraces a method of building a wall. The disclosed method of building a wall may generally include utilizing the disclosed modular connector system in any embodiment and/or combination of embodiments shown and/or described herein. Accordingly, in general, the disclosed method of building a wall may include providing a modular connector system for setting building material members in place prior to construction of the wall, where the modular connector system includes: a base plate configured to support the modular connector system; a vertical riser member affixed to the base plate in a vertical orientation; at least one horizontal arm, each of the at least one horizontal arm is configured to be adjustably positioned along the vertical riser member; and each of the at least one horizontal arm including a connection member, the connection member is configured to attach to one of the building material members. With the provided modular connector system, the method for building a wall may further include: setting the building material members in place via the provided modular connector system; and constructing the wall with the building material members set in place via the provided modular connector system.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is perspective view of the disclosed modular connector system configured for setting building material members in place prior to construction of a wall according to select embodiments of the instant disclosure;

FIG. 2A is another perspective view of the base plate and vertical riser member of the disclosed modular connector system configured for setting building material members in place prior to construction of a wall according to select embodiments of the instant disclosure;

FIG. 2B is a zoomed in perspective view of the vertical riser member shown in FIG. 2A showing the length locking mechanism according to select embodiments of the instant disclosure;

FIG. 2C is a zoomed in perspective view of the length locking mechanism shown in FIGS. 2A and 2B showing the threaded T-handle;

FIG. 3A is a top perspective view of the base plate of the disclosed modular connector system configured for setting building material members in place prior to construction of a wall according to select embodiments of the instant disclosure;

FIG. 3B is a bottom perspective view of the base plate from FIG. 3A;

FIG. 3C is a side view of the base plate from FIGS. 3A and 3B;

FIG. 4 is a zoomed in perspective view of the vertical to horizontal transfer knuckle for the disclosed modular connector system configured for setting building material members in place prior to construction of a wall according to select embodiments of the instant disclosure;

FIG. 5 is a zoomed in perspective view of the connection member partially disassembled from one of the horizontal arms for the disclosed modular connector system configured for setting building material members in place prior to construction of a wall according to select embodiments of the instant disclosure, showing an adjustable building material clamp partially disassembled from a building material member (i.e., vertical piping);

FIG. 6 is a zoomed in perspective view of multiple connection members connected on horizontal arms for the disclosed modular connector system configured for setting building material members in place prior to construction of a wall according to select embodiments of the instant disclosure, showing multiple adjustable building material clamps attached on a building material member (i.e., vertical piping);

FIG. 7 is a top perspective view of the disclosed modular connector system configured for setting building material members in place prior to construction of a wall according to select embodiments of the instant disclosure, showing the system used for horizontal piping or conduits that are set in position while the wall is being built;

FIG. 8 is a top perspective view of the disclosed modular connector system configured for setting building material members in place prior to construction of a wall according to select embodiments of the instant disclosure, showing the system used for horizontal piping or conduits that are set in position while the wall is being built and utilizing an adjustable horizontal support on one of the horizontal arms for keeping the system level;

FIG. 9 is a front perspective photo view of the disclosed modular connector system configured for setting building material members in place prior to construction of a wall according to select embodiments of the instant disclosure, showing the system in use building a wall;

FIG. 10 is a side perspective photo view of the disclosed modular connector system configured for setting building material members in place prior to construction of a wall according to select embodiments of the instant disclosure, showing the system in use building a wall;

FIG. 11 is another side perspective photo view of the disclosed modular connector system configured for setting building material members in place prior to construction of a wall according to select embodiments of the instant disclosure, showing the system in use building a wall;

FIG. 12 is a zoomed in front perspective photo view of the disclosed modular connector system configured for setting building material members in place prior to construction of a wall according to select embodiments of the instant disclosure, showing the system in use building a wall; and

FIG. 13 is a flow diagram of the method of building a wall utilizing the disclosed modular connector system according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

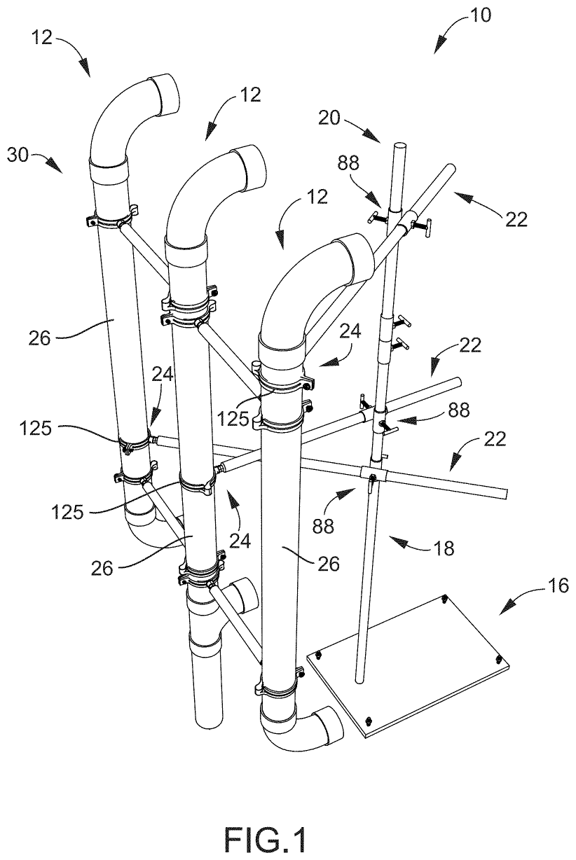

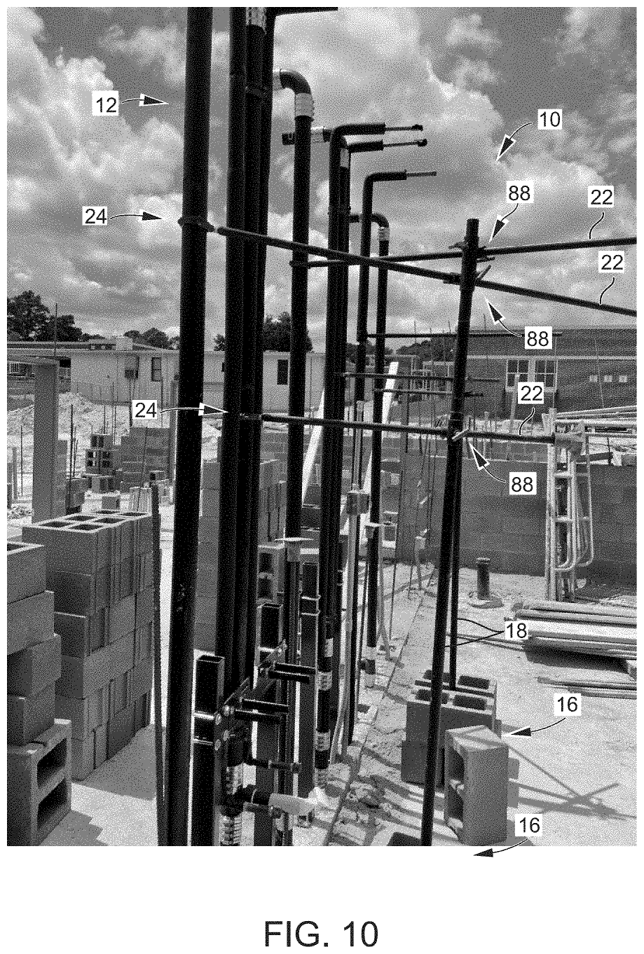

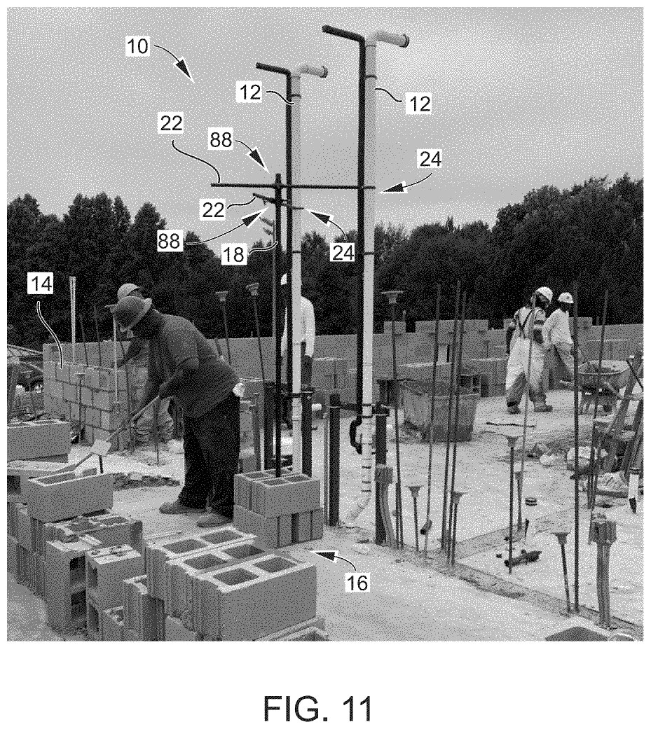

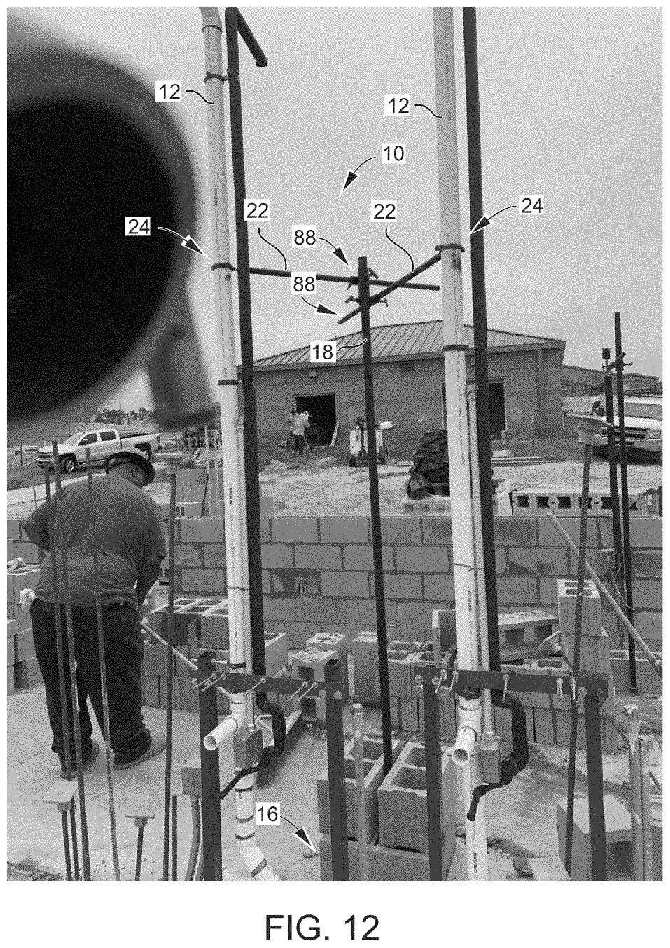

Referring now to FIGS. 1-13, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring to FIGS. 1-12, the present disclosure may solve the aforementioned limitations of the currently available building materials and installation thereof by providing modular connector system 10. Modular connector system 10 may be designed and/or configured for setting various building material members 12 in place prior to construction of wall 14. Modular connector system 10 may generally include base plate 16, vertical riser member 18, at least one horizontal arm 22, and a connection member 24 for each of the at least one horizontal arm 22. Base plate 16 may be configured to support modular connector system 10. Vertical riser member 18 may be affixed to base plate 16 in vertical orientation 20. Each of the at least one horizontal arm 22 may be configured to be adjustably positioned along vertical riser member 18. Connection member 24 on each of the horizontal arms 22 may be configured to attach to one of the building material members 12. Wherein, modular connector system 10 may be designed and/or configured for setting building material members 12 in place prior to construction of wall 14. As an example, and clearly not limited thereto, when building material members 12 are vertical piping 26, horizontal piping 28, and/or prefab assemblies 30, modular connector system 10 may be designed and/or configured for setting vertical piping 26, horizontal piping 28 or prefab assemblies 30 in place prior to construction of wall 14, like for any utilities, including but not limited to, electrical, plumbing, HVAC, the like, etc.

As shown in FIG. 1, modular connector system 10 may include a plurality of horizontal arms 22 attached to vertical riser member 18 for supporting a variety of different building material members 12, like vertical piping 26, conduit, horizontal piping 28, or prefab assemblies 30. Modular connector system 10 may be designed and configured to set any desired amount, shape, size, style configuration, the like, etc. of building material members 12 prior to constructing wall 14, including any utility building material members 12, like electrical, plumbing, HVAC, the like, etc.

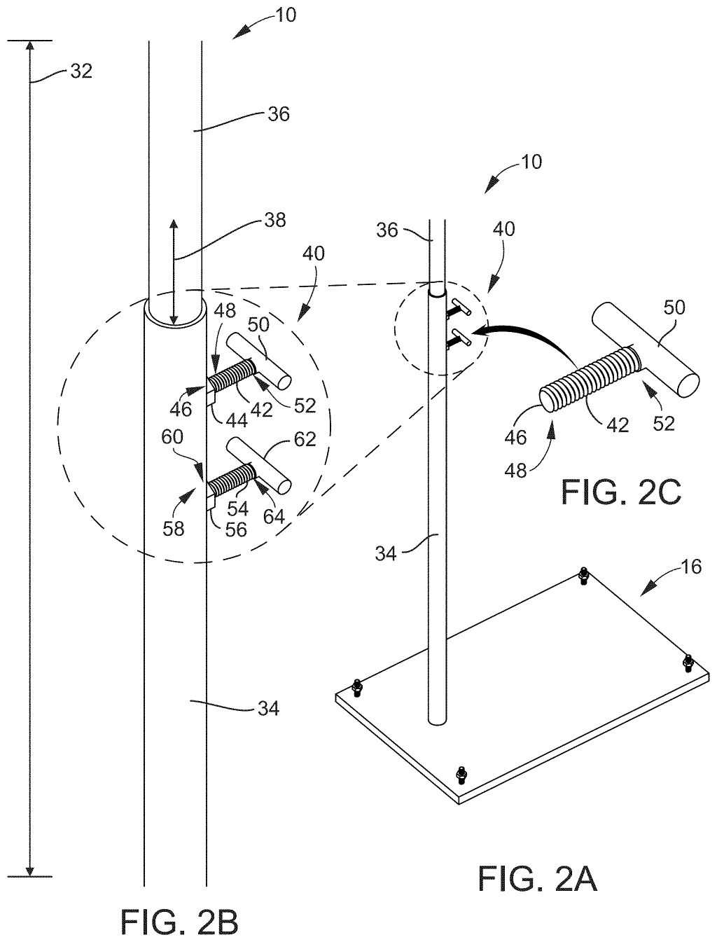

Referring now specifically to FIGS. 2A, 2B and 2C, one feature of modular connector system 10 may be that vertical riser member 18 can include adjustable height 32. Vertical riser member 18 may be configured with adjustable height 32 by any means and/or mechanisms. As best shown in FIG. 2B, in select embodiments, vertical riser member 18 may include outer tube riser member 34 and inner tube riser member 36 (or a plurality of inner tube riser members 36). Outer tube riser member 34 may be affixed to base plate 16. Inner tube riser member 36 may be telescopically engaged with outer tube riser member 34 (or vice versa). Wherein, adjustable height 32 of vertical riser member 18 may be configured to be lengthened by telescopically extending inner tube riser member 36 from outer tube riser member 34. Likewise, in reverse, adjustable height 32 of vertical riser member 18 may be configured to be shortened by telescopically retracting inner tube riser member 36 into outer tube riser member 34.

Still referring to FIGS. 2A, 2B and 2C, another feature of modular connector system 10 may be that adjustable height 32 of vertical riser member 18 may be configured to be locked into desired length 38 via length locking mechanism 40. Desired length 38 may be any desired length or height for vertical riser member 18 for providing any desired height for positioning horizontal arms 22 above base plate 16. In select embodiments, length locking mechanism 40 may include threaded length locking portion 42, inner tube engaging end 46, and length locking T-handle portion end 50. Threaded length locking portion 42 may be threadedly engaged through threaded length locking hole 44 in outer tube riser member 34. Inner tube engaging end 46 may be on inner end 48 of threaded length locking portion 42. Inner tube engaging end 46 may be configured to engage inner tube riser member 36 inside of outer tube riser member 34. Length locking T-handle portion end 50 may be on outer end 52 of threaded length locking portion 42. Length locking T-handle portion end 50 may be configured to be manipulated for rotating threaded length locking portion 42. Wherein, length locking mechanism 40 may be configured to securely position inner tube riser member 36 at desired length 38 about outer tube riser member 34 by rotating threaded length locking portion 42 engaged in threaded length locking hole 44 in outer tube riser member 34 via length locking T-handle portion end 50, thereby, engaging and disengaging inner tube engaging end 46 against inner tube riser member 36. In select embodiments of modular connector system 10, length locking mechanism 40 may further include a second T-handle locking mechanism for further securing desired length 38 of vertical riser member 18. This second T-handle locking mechanism may include second threaded length locking portion 54, second inner tube engaging end 58, and second length locking T-handle portion end 62. Second threaded length locking portion 54 may be threadedly engaged through second threaded length locking hole 56 in outer tube riser member 34. Second inner tube engaging end 58 may be on second inner end 60 of second threaded length locking portion 54. Second inner tube engaging end 58 may be configured to engage inner tube riser member 36 inside of outer tube riser member 34. Second length locking T-handle portion end 62 may be on second outer end 64 of second threaded length locking portion 54. Second length locking T-handle portion end 62 may be configured to be manipulated for rotating second threaded length locking portion 54. Wherein, length locking mechanism 40 may be configured to securely position inner tube riser member 36 at desired length 38 about outer tube riser member 34 by rotating second threaded length locking portion 54 engaged in second threaded length locking hole 56 in outer tube riser member 34 via second length locking T-handle portion end 62, thereby, engaging and disengaging second inner tube engaging end 58 against inner tube riser member 36.

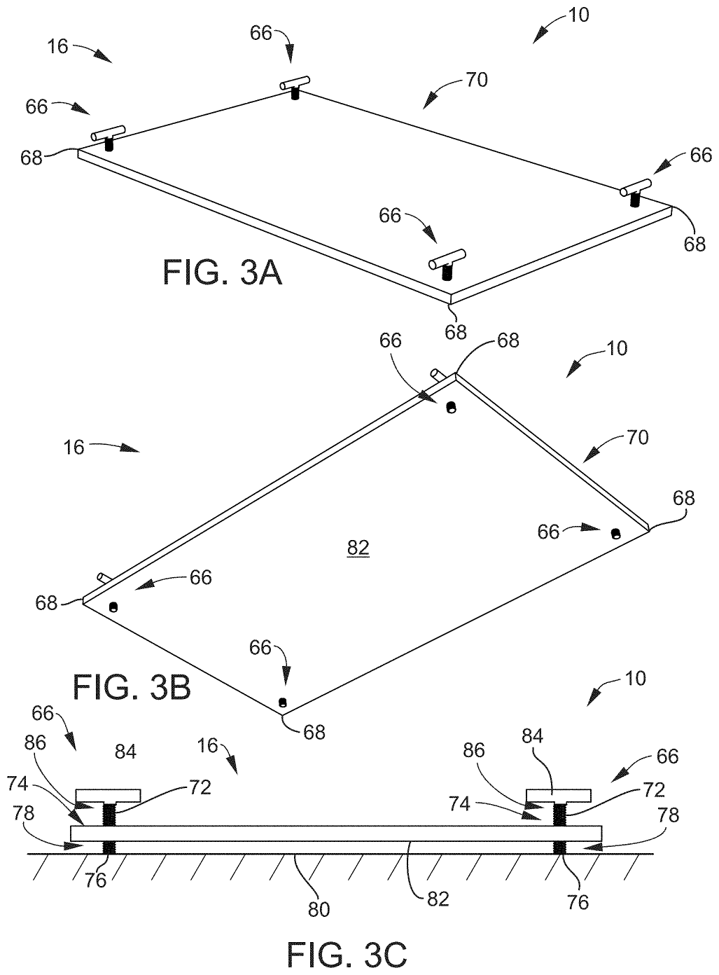

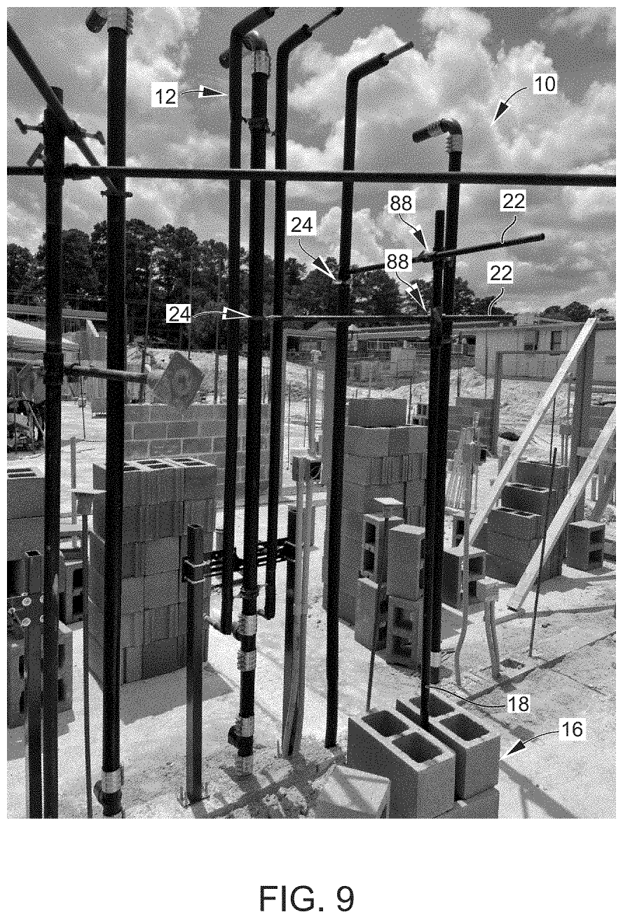

Referring now specifically to FIGS. 3A, 3B and 3C, another feature of modular connector system 10 may be that base plate 16 can be configured to be leveled. Base plate 16 can be configured to be leveled by any means and/or mechanisms. As shown in FIGS. 3A, 3B and 3C, in select embodiments, base plate 16 may include at least one independent leveling foot 66 configured for leveling base plate 16. Base plate 16 may include any number of desired independent leveling feet 66. In select possibly preferred embodiments, as shown in the Figures, base plate 16 may include four independent leveling feet 66. Each of the four independent leveling feet 66 may be configured for independently leveling base plate 16. Each of the four independent leveling feet 66 may be positioned approximate corner 68 of rectangular shape 70 of base plate 16. Independent leveling feet 66 may include any means and/or mechanisms for being leveling feet for base plate 16. In select embodiments, as shown in the Figures, each of the at least one independent leveling feet 66 may include threaded leveling portion 72, bottom surface engaging end 76, and leveling T-handle portion end 84. Threaded leveling portion 72 may be threadedly engaged through threaded leveling hole 74 in base plate 16. Bottom surface engaging end 76 may be on bottom end 78 of threaded leveling portion 72. Bottom surface engaging end 76 may be configured to engage surface 80 (see FIG. 3C) below bottom side 82 of base plate 16. Leveling T-handle portion end 84 may be on top end 86 of threaded leveling portion 72. Leveling T-handle portion end 84 may be configured to be manipulated for rotating threaded leveling portion 72. Wherein, each of the at least one independent leveling foot 66 may be configured to level base plate 16 by rotating threaded leveling portion 72 engaged in threaded leveling hole 74 in base plate 16 via leveling T-handle portion end 84, thereby, raising or lowering bottom surface engaging end 76. Base plate 16 may be sized and configured to support modular connector system 10 and may be configured to receive a weighted object thereon, including, but not limited to a cinder block or multiple cinder blocks as shown in the photos of FIGS. 9, 10, 11 and 12. These weighted objects may be loaded onto base plate 16 for stabilizing modular connector system 10 to prevent modular connector system 10 from tipping over, like when building material members 12 are attached on connector members 24 on the ends of horizontal arms 22.

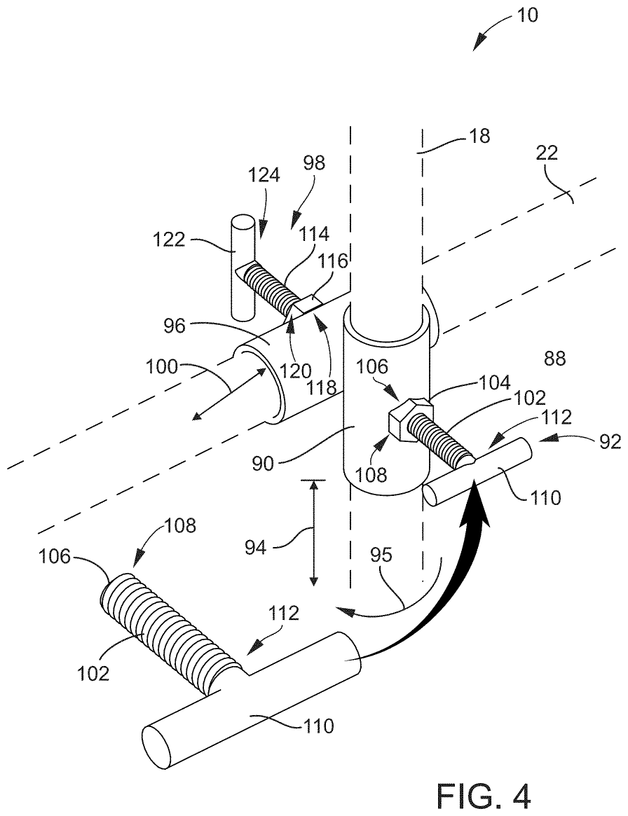

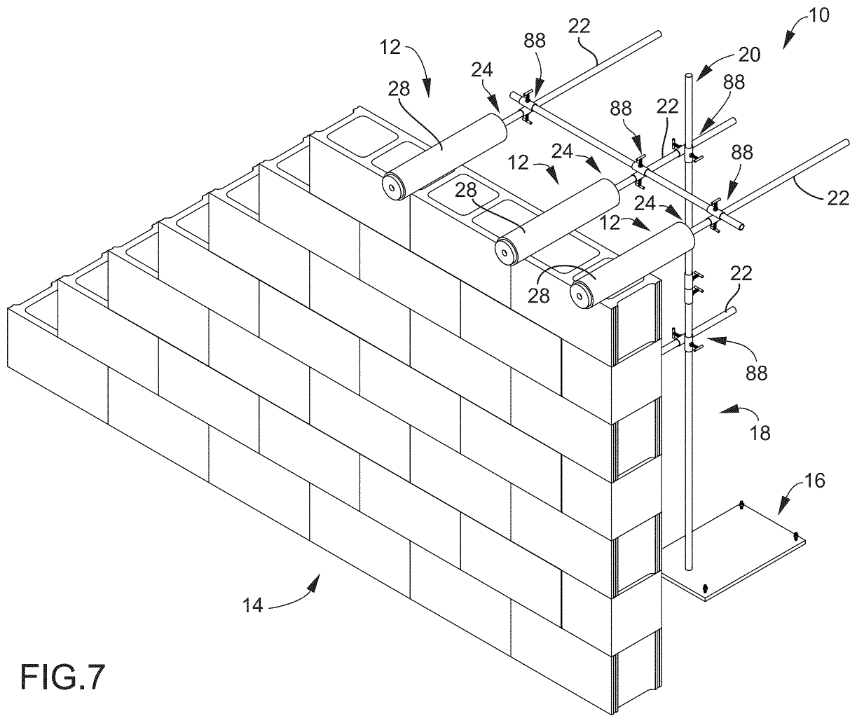

Referring now specifically to FIG. 4, another feature of modular connector system 10 may be the inclusion of at least one vertical to horizontal transfer knuckle 88. Each of the at least one horizontal arm 22 may be configured to be adjustably positioned along vertical riser member 18 via one of the at least one vertical to horizontal transfer knuckles 88. Vertical to horizontal transfer knuckle 88 may include any mean and/or mechanism for adjustably positioning horizontal arm 22 along vertical riser member 18. As shown in the Figures, in select embodiments, each of the at least one vertical to horizontal transfer knuckles 88 may include vertical tube portion 90 and horizontal tube portion 96. Vertical tube portion 90 may be adjustably positioned along vertical riser member 18. Vertical tube portion 90 may include first knuckle adjustment mechanism 92 configured to securely position vertical tube portion 90 at desired height 94 and desired radial orientation 95 about vertical riser member 18. First knuckle adjustment mechanism 92 may include any means and/or mechanism for securely positioning vertical tube portion 90 at desired height 94 and desired radial orientation 95 about vertical riser member 18. Horizontal tube portion 96 may be secured to vertical tube portion 90 in horizontal orientation 97. Horizontal tube portion 96 may include second knuckle adjustment mechanism 98 configured to securely position one of the at least one horizontal arm 22 at desired depth 100 about vertical riser member 18. Second knuckle adjustment mechanism 98 may include any means and/or mechanism for securely positioning a horizontal arm 22 at desired depth 100 about vertical riser member 18. Wherein, each of the at least one vertical to horizontal transfer knuckles 88 may be configured to orient one of the at least one horizontal arm 22 at desired height 94, desired radial orientation 95, and desired depth 100 about vertical riser member 18. In select embodiments, first knuckle adjustment mechanism 92 may include first knuckle threaded portion 102, vertical riser engaging end 106, and first knuckle T-handle portion end 110. First knuckle threaded portion 102 may be threadedly engaged through first knuckle threaded hole 104 in vertical tube portion 90. Vertical riser engaging end 106 may be on first distal end 108 of first knuckle threaded portion 102. Vertical riser engaging end 106 may be configured to engage vertical riser member 18 inside of vertical tube portion 90. First knuckle T-handle portion end 110 may be on first proximal end 112 of first knuckle threaded portion 102. First knuckle T-handle portion end 110 may be configured to be manipulated for rotating first knuckle threaded portion 102. Wherein, first knuckle adjustment mechanism 92 may be configured to securely position vertical tube portion 90 at desired height 94 and desired radial orientation 95 about vertical riser member 18 by rotating first knuckle threaded portion 102 engaged in first knuckle threaded hole 104 in vertical tube portion 90 via first knuckle T-handle portion end 110, thereby, engaging and disengaging vertical riser engaging end 106 against vertical riser member 18. In other select embodiments, second knuckle adjustment mechanism 98 may include second knuckle threaded portion 114, horizontal arm engaging end 118, and second knuckle T-handle portion end 122. Second knuckle threaded portion 114 may be threadedly engaged through second knuckle threaded hole 116 in horizontal tube portion 96. Horizontal arm engaging end 118 may be on second distal end 120 of second knuckle threaded portion 114. Horizontal arm engaging end 118 may be configured to engage horizontal arm 22 inside of horizontal tube portion 96. Second knuckle T-handle portion end 122 may be on second proximal end 124 of second knuckle threaded portion 114. Second knuckle T-handle portion end 122 may be configured to be manipulated for rotating second knuckle threaded portion 114. Wherein, second knuckle adjustment mechanism 98 may be configured to securely position horizontal arm 22 inside of horizontal tube portion 96 at desired depth 100 about vertical riser member 18 by rotating second knuckle threaded portion 114 engaged in second knuckle threaded hole 116 in horizontal tube portion 96 via second knuckle T-handle portion end 122, thereby, engaging and disengaging horizontal arm engaging end 118 against horizontal arm 22. As shown in FIG. 7, vertical to horizontal transfer knuckles 88 may also be utilized to connect together multiple horizontal arms 22 at the same desired height 94 about vertical riser member 18.

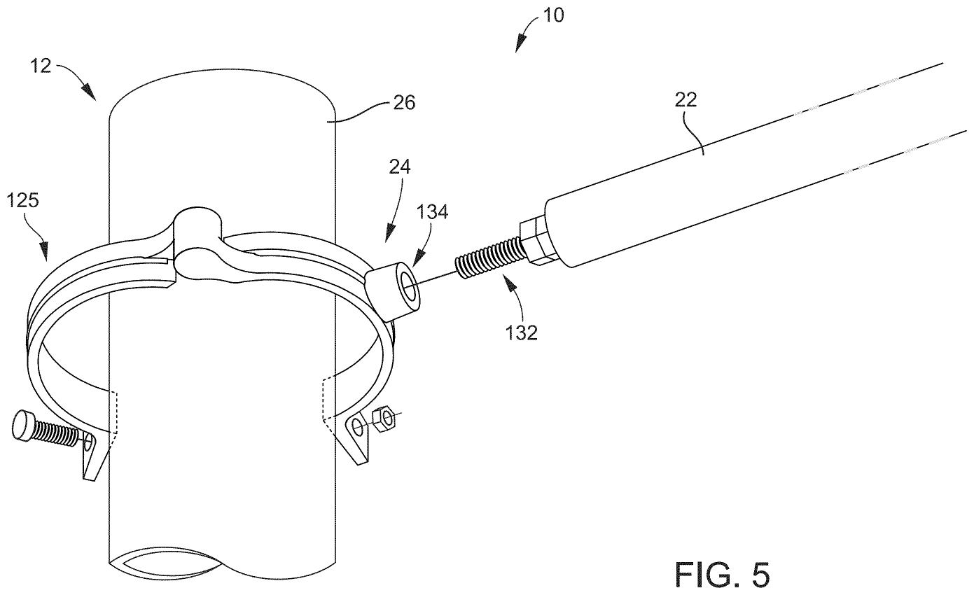

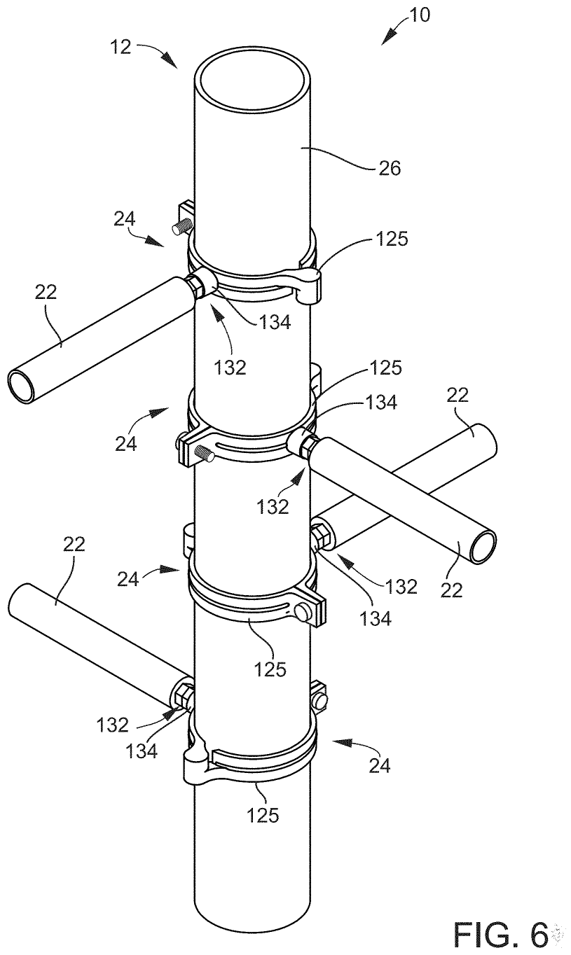

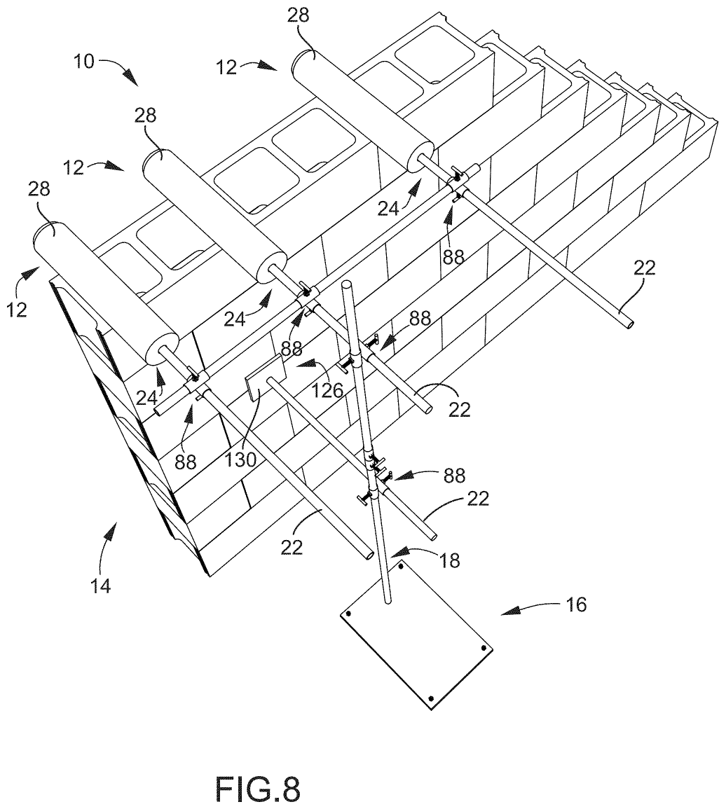

Referring now specifically to FIGS. 5, 6, 7 and 8, another feature of modular connector system 10 may be that connection member 24 of each of the at least one horizontal arm 22 may include various types, shapes, sizes and/or configurations of connections for various types, shapes, sizes and/or configurations of building material members 12. In select embodiments, connection member 24 of each of the at least one horizontal arm may include adjustable building material clamp 125 (see FIGS. 5 and 6) and/or an adjustable horizontal support (see FIG. 8). Each of the adjustable building material clamps 125 may be removably attached to one of the horizontal arms 22. Each of the adjustable horizontal supports 126 may also be removably attached to one of the horizontal arms 22. These two connection members 24 may be interchangeable on various horizontal arms 22. As shown in FIG. 8, adjustable horizontal support 126 may be configured for leveling modular connector system 10 by applying force to wall 14 or fixed support 128. In select embodiments of modular connector system 10, adjustable building material clamp 125 may be configured for attaching to vertical piping 26 (see FIGS. 5 and 6), horizontal piping 28 (see FIGS. 7 and 8), or prefab assemblies 30 (see FIG. 1). In other select embodiments of modular connector system 10, adjustable horizontal support 126 may include support member 130 configured to engage wall 14 or fixed support 128 for leveling and supporting modular connector system 10, like for preventing modular connector system 10 from tipping over due to forces from holding building material members 12. Connection member 24, including, but not limited to adjustable building material clamp 125 and/or adjustable horizontal support 126 may be removably attached to one of the horizontal arms 22 by any means and/or mechanism. As best shown in FIG. 5, in select embodiments, each of the at least one horizontal arms 22 may include first threaded connection point 132 and adjustable building material clamp 125 and/or adjustable horizontal support 126 may include second threaded connection point 134 affixed thereto. Wherein, adjustable building material clamp 125 or adjustable horizontal support 126 may be configured to be removably connected to one of the at least one horizontal arms 22 by threadedly engaging second threaded connection point 134 affixed to adjustable building material clamp 125 or adjustable horizontal support 126 onto first threaded connection point 132 on horizontal arm 22.

In another aspect, the instant disclosure embraces modular connector system 10 in any embodiment and/or combination of embodiments shown and/or described herein.

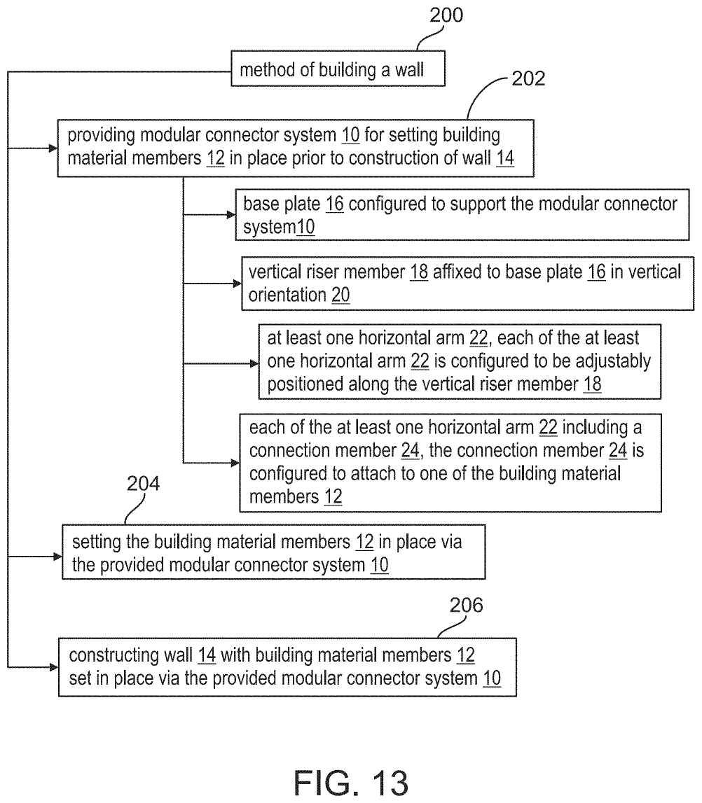

Referring now to FIG. 13, in another aspect, the instant disclosure embraces method 200 of building wall 14. Method 200 of building wall 14 may generally include utilizing the disclosed modular connector system 10 in any embodiment and/or combination of embodiments shown and/or described herein. Accordingly, in general, method 200 of building wall 14 may include step 202 of providing modular connector system 10 for setting building material members 12 in place prior to construction of wall 14, where modular connector system 10 includes: base plate 16 configured to support modular connector system 10; vertical riser member 18 affixed to base plate 16 in vertical orientation 20; at least one horizontal arm 22, each of the at least one horizontal arm 22 is configured to be adjustably positioned along vertical riser member 18; and each of the at least one horizontal arm 22 including connection member 24 configured to attach to one of the building material members 12. With the provided modular connector system 10, method 200 for building wall 14 may further include: step 204 of setting building material members 12 in place via the provided modular connector system 10; and step 206 of constructing wall 14 with building material members 12 set in place via the provided modular connector system 10. Method 200 may also include any other steps or procedures for utilizing the disclosed modular connector system 10 for setting various building material members 12 in place prior to construction of wall 14, and any steps or procedures for constructing wall 14.

In sum, the disclosed modular connector system 10 has been designed to make the pre-installation of vertical/horizontal stands of piping, prefab assemblies, conduit and/or duct easier and more efficient. The disclosed modular connector system 10 may be fully adjustable in height and reach so that the user can set it up out of the way of the mason or other trades. The disclosed modular connector system 10 may be designed with removable and/or interchangeable adjustable building material clamps 125 so that different size pipes, conduit or duct can be held. Base plate 16 of the disclosed modular connector system 10 may feature 4 independent leveling feet 66, which can also serve as securing points for the assembly of the disclosed modular connector system 10.

The primary advantage of the disclosed modular connector system 10 may be its ability to set vertical or horizontal piping/prefab assemblies in place prior to wall construction, saving the user significant time and avoiding the potential errors.

The disclosed modular connector system may be fully adjustable to meet almost any application and clamp ends can be modified to hold a variety of materials.

The disclosed modular connector system 10 can be setup by one person eliminating the need for multiple men per piping run.

The disclosed modular connector system 10 may utilize a modular design allowing the user to configure the system in multiple ways. The disclosed modular connector system 10 can hold multiple horizontal sleeves or vertical sleeves depending on the configuration.

The disclosed modular connector system 10 may be designed to hold pipe, sleeve material, duct, etc. during the construction process. Modular connector system 10 may be designed to be used with various construction materials, sizes & configurations. Wherein, during the construction process it is necessary for plumbing pipes, electrical conduit, duct, etc. to be installed within the walls and having these materials in place prior to wall construction saves time and money for the contractor. As examples, and clearly not limited thereto, the disclosed modular connector system 10 can be configured to hold vertical stands of pipe, horizontal sleeves and/or block outs for duct. The modular design, adjustability and variety of attachment points may make modular connector system adaptable to almost any application or trade.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A modular connector system for setting building material members in place prior to construction of a wall, the modular connector system comprising:
a base plate configured to support the modular connector system;
a vertical riser member affixed to the base plate in a vertical orientation;
at least one horizontal arm, each of the at least one horizontal arm is configured to be adjustably positioned along the vertical riser member; and
each of the at least one horizontal arm including a connection member, the connection member is configured to attach to one of the building material members.

2. The modular connector system of claim 1 being designed and configured for setting the building material members in place prior to construction of the wall.

3. The modular connector system of claim 2, wherein the building material members are vertical piping, horizontal piping, or prefab assemblies, where the modular connector system is designed and configured for setting the vertical piping, the horizontal piping or the prefab assemblies in place prior to construction of the wall.

4. The modular connector system according to claim 1, wherein the vertical riser member including an adjustable height.

5. The modular connector system according to claim 4, wherein the vertical riser member including:
an outer tube riser member affixed to the base plate;
an inner tube riser member telescopically engaged with the outer tube riser member;
wherein:
the adjustable height of the vertical riser member is configured to be lengthened by telescopically extending the inner tube riser member from the outer tube riser member; and
the adjustable height of the vertical riser member is configured to be shortened by telescopically retracting the inner tube riser member into the outer tube riser member.

6. The modular connector system according to claim 5, wherein the adjustable height of the vertical riser member is configured to be locked into a desired length via a length locking mechanism.

7. The modular connector system according to claim 6, wherein the length locking mechanism including:
a threaded length locking portion threadedly engaged through a threaded length locking hole in the outer tube riser member;
an inner tube engaging end on an inner end of the threaded length locking portion, the inner tube engaging end is configured to engage the inner tube riser member inside of the outer tube riser member;
a length locking T-handle portion end on an outer end of the threaded length locking portion, the length locking T-handle portion end is configured to be manipulated for rotating the threaded length locking portion; and
wherein, the length locking mechanism is configured to securely position the inner tube riser member at the desired length about the outer tube riser member by rotating the threaded length locking portion engaged in the threaded length locking hole in the outer tube riser member via the length locking T-handle portion end, thereby, engaging and disengaging the inner tube engaging end against the inner tube riser member.

8. The modular connector system according to claim 7, wherein the length locking mechanism further including:
a second threaded length locking portion threadedly engaged through a second threaded length locking hole in the outer tube riser member;
a second inner tube engaging end on a second inner end of the second threaded length locking portion, the second inner tube engaging end is configured to engage the inner tube riser member inside of the outer tube riser member;
a second length locking T-handle portion end on a second outer end of the second threaded length locking portion, the second length locking T-handle portion end is configured to be manipulated for rotating the second threaded length locking portion; and
wherein, the length locking mechanism is configured to securely position the inner tube riser member at the desired length about the outer tube riser member by rotating the second threaded length locking portion engaged in the second threaded length locking hole in the outer tube riser member via the second length locking T-handle portion end, thereby, engaging and disengaging the second inner tube engaging end against the inner tube riser member.

9. The modular connector system according to claim 1, wherein the base plate is configured to be leveled.

10. The modular connector system according to claim 9, wherein the base plate including at least one independent leveling foot configured for leveling the base plate.

11. The modular connector system according to claim 10, wherein the base plate including four independent leveling feet, each of the four independent leveling feet are configured for independently leveling the base plate, and each of the four independent leveling feet are positioned approximate a corner of a rectangular shape of the base plate.

12. The modular connector system according to claim 10, wherein each of the at least one independent leveling feet including:
a threaded leveling portion threadedly engaged through a threaded leveling hole in the base plate;
a bottom surface engaging end on a bottom end of the threaded leveling portion, the bottom surface engaging end is configured to engage a surface below a bottom side of the base plate;
a leveling T-handle portion end on a top end of the threaded leveling portion, the leveling T-handle portion end is configured to be manipulated for rotating the threaded leveling portion; and
wherein, each of the at least one independent leveling feet is configured to level the base plate by rotating the threaded leveling portion engaged in the threaded leveling hole in the base plate via the leveling T-handle portion end, thereby, raising or lowering the bottom surface engaging end.

13. The modular connector system according to claim 1 further including at least one vertical to horizontal transfer knuckle, wherein each of the at least one horizontal arm is configured to be adjustably positioned along the vertical riser member via one of the at least one vertical to horizontal transfer knuckles.

14. The modular connector system according to claim 13, wherein each of the at least one vertical to horizontal transfer knuckles including:
a vertical tube portion positioned along the vertical riser member, the vertical tube portion includes a first knuckle adjustment mechanism configured to securely position the vertical tube portion at a desired height and a desired radial orientation about the vertical riser member;
a horizontal tube portion secured to the vertical tube portion in a horizontal orientation, the horizontal tube portion includes a second knuckle adjustment mechanism configured to securely position one of the at least one horizontal arms at a desired depth about the vertical riser member; and
wherein, each of the at least one vertical to horizontal transfer knuckles is configured to orient one of the at least one horizontal arms at the desired height, the desired radial orientation, and the desired depth about the vertical riser member.

15. The modular connector system according to claim 14, wherein:
the first knuckle adjustment mechanism including:
a first knuckle threaded portion threadedly engaged through a first knuckle threaded hole in the vertical tube portion;
a vertical riser engaging end on a first distal end of the first knuckle threaded portion, the vertical riser engaging end is configured to engage the vertical riser member inside of the vertical tube portion;
a first knuckle T-handle portion end on a first proximal end of the first knuckle threaded portion, the first knuckle T-handle portion end is configured to be manipulated for rotating the first knuckle threaded portion;
wherein, the first knuckle adjustment mechanism is configured to securely position the vertical tube portion at the desired height and the desired radial orientation about the vertical riser member by rotating the first knuckle threaded portion engaged in the first knuckle threaded hole in the vertical tube portion via the first knuckle T-handle portion end, thereby, engaging and disengaging the vertical riser engaging end against the vertical riser member;
the second knuckle adjustment mechanism including:
a second knuckle threaded portion threadedly engaged through a second knuckle threaded hole in the horizontal tube portion;
a horizontal arm engaging end on a second distal end of the second knuckle threaded portion, the horizontal arm engaging end is configured to engage the horizontal arm inside of the horizontal tube portion;
a second knuckle T-handle portion end on a second proximal end of the second knuckle threaded portion, the second knuckle T-handle portion end is configured to be manipulated for rotating the second knuckle threaded portion; and
wherein, the second knuckle adjustment mechanism is configured to securely position the horizontal arm inside of the horizontal tube portion at the desired depth about the vertical riser member by rotating the second knuckle threaded portion engaged in the second knuckle threaded hole in the horizontal tube portion via the second knuckle T-handle portion end, thereby, engaging and disengaging the horizontal arm engaging end against the horizontal arm.

16. The modular connector system according to claim 1, wherein the connection member of each of the at least one horizontal arm including:
an adjustable building material clamp removably attached to the horizontal arm; or
an adjustable horizontal support removably attached to the horizontal arm, the adjustable horizontal support is configured for leveling the modular connector system by applying force to the wall or a fixed support.

17. The modular connector system according to claim 16, wherein:
the adjustable building material clamp is configured for attaching to vertical piping, horizontal piping, or prefab assemblies; or
the adjustable horizontal support including a support member configured to engage the wall or the fixed support for leveling the modular connector system.

18. The modular connector system according to claim 16, wherein:
each of the at least one horizontal arms including a first threaded connection point;
the adjustable building material clamp or the adjustable horizontal support including a second threaded connection point affixed thereto; and
wherein, the adjustable building material clamp or the adjustable horizontal support is configured to be removably connected to one of the at least one horizontal arms by threadedly engaging the second threaded connection point affixed to the adjustable building material clamp or the adjustable horizontal support onto the first threaded connection point on the horizontal arm.

19. A modular connector system for setting building material members in place prior to construction of a wall, the modular connector system comprising:
a base plate configured to support the modular connector system, the base plate is configured to be leveled, the base plate comprising:
four independent leveling feet, each of the four independent leveling feet are configured for independently leveling the base plate, and each of the four independent leveling feet are positioned approximate a corner of a rectangular shape of the base plate;
each of the four independent leveling feet including:
a threaded leveling portion threadedly engaged through a threaded leveling hole in the base plate;
a bottom surface engaging end on a bottom end of the threaded leveling portion, the bottom surface engaging end is configured to engage a surface below a bottom side of the base plate;
a leveling T-handle portion end on a top end of the threaded leveling portion, the leveling T-handle portion end is configured to be manipulated for rotating the threaded leveling portion;
wherein, each of the four independent leveling feet is configured to level the base plate by rotating the threaded leveling portion engaged in the threaded leveling hole in the base plate via the leveling T-handle portion end, thereby, raising or lowering the bottom surface engaging end;
a vertical riser member affixed to the base plate in a vertical orientation, the vertical riser member including an adjustable height, the vertical riser member including:
an outer tube riser member affixed to the base plate;
an inner tube riser member telescopically engaged with the outer tube riser member;
wherein:
the adjustable height of the vertical riser member is configured to be lengthened by telescopically extending the inner tube riser member from the outer tube riser member;
the adjustable height of the vertical riser member is configured to be shortened by telescopically retracting the inner tube riser member into the outer tube riser member;
wherein the adjustable height of the vertical riser member is configured to be locked into a desired length via a length locking mechanism, the length locking mechanism including:
a threaded length locking portion threadedly engaged through a threaded length locking hole in the outer tube riser member;
an inner tube engaging end on an inner end of the threaded length locking portion, the inner tube engaging end is configured to engage the inner tube riser member inside of the outer tube riser member;
a length locking T-handle portion end on an outer end of the threaded length locking portion, the length locking T-handle portion end is configured to be manipulated for rotating the threaded length locking portion;
a second threaded length locking portion threadedly engaged through a second threaded length locking hole in the outer tube riser member;
a second inner tube engaging end on a second inner end of the second threaded length locking portion, the second inner tube engaging end is configured to engage the inner tube riser member inside of the outer tube riser member;
a second length locking T-handle portion end on a second outer end of the second threaded length locking portion, the second length locking T-handle portion end is configured to be manipulated for rotating the second threaded length locking portion;
wherein, the length locking mechanism is configured to securely position the inner tube riser member at the desired length about the outer tube riser member by rotating the threaded length locking portion engaged in the threaded length locking hole in the outer tube riser member via the length locking T-handle portion end and rotating the second threaded length locking portion engaged in the second threaded length locking hole in the outer tube riser member via the second length locking T-handle portion end, thereby, engaging and disengaging the second inner tube engaging end against the inner tube riser member;
at least one horizontal arm, each of the at least one horizontal arm is configured to be adjustably positioned along the vertical riser member;
at least one vertical to horizontal transfer knuckle, wherein each of the at least one horizontal arm is configured to be adjustably positioned along the vertical riser member via one of the at least one vertical to horizontal transfer knuckles, each of the at least one vertical to horizontal transfer knuckles including:
a vertical tube portion positioned along the vertical riser member, the vertical tube portion includes a first knuckle adjustment mechanism configured to securely position the vertical tube portion at a desired height and a desired radial orientation about the vertical riser member;
a horizontal tube portion secured to the vertical tube portion in a horizontal orientation, the horizontal tube portion includes a second knuckle adjustment mechanism configured to securely position one of the at least one horizontal arms at a desired depth about the vertical riser member;
wherein, each of the at least one vertical to horizontal transfer knuckles is configured to orient one of the at least one horizontal arms at the desired height, the desired radial orientation, and the desired depth about the vertical riser member, wherein:
the first knuckle adjustment mechanism including:
a first knuckle threaded portion threadedly engaged through a first knuckle threaded hole in the vertical tube portion;
a vertical riser engaging end on a first distal end of the first knuckle threaded portion, the vertical riser engaging end is configured to engage the vertical riser member inside of the vertical tube portion;
a first knuckle T-handle portion end on a first proximal end of the first knuckle threaded portion, the first knuckle T-handle portion end is configured to be manipulated for rotating the first knuckle threaded portion;
wherein, the first knuckle adjustment mechanism is configured to securely position the vertical tube portion at the desired height and the desired radial orientation about the vertical riser member by rotating the first knuckle threaded portion engaged in the first knuckle threaded hole in the vertical tube portion via the first knuckle T-handle portion end,
thereby, engaging and disengaging the vertical riser engaging end against the vertical riser member;
the second knuckle adjustment mechanism including:
a second knuckle threaded portion threadedly engaged through a second knuckle threaded hole in the horizontal tube portion;
a horizontal arm engaging end on a second distal end of the second knuckle threaded portion, the horizontal arm engaging end is configured to engage the horizontal arm inside of the horizontal tube portion;
a second knuckle T-handle portion end on a second proximal end of the second knuckle threaded portion, the second knuckle T-handle portion end is configured to be manipulated for rotating the second knuckle threaded portion;
wherein, the second knuckle adjustment mechanism is configured to securely position the horizontal arm inside of the horizontal tube portion at the desired depth about the vertical riser member by rotating the second knuckle threaded portion engaged in the second knuckle threaded hole in the horizontal tube portion via the second knuckle T-handle portion end, thereby, engaging and disengaging the horizontal arm engaging end against the horizontal arm;
each of the at least one horizontal arm including a connection member, the connection member is configured to attach to one of the building material members, the connection member of each of the at least one horizontal arm including:
an adjustable building material clamp removably attached to the horizontal arm, the adjustable building material clamp is configured for attaching to vertical piping, horizontal piping, or prefab assemblies; or
an adjustable horizontal support configured for leveling the modular connector system by applying force to the wall or a fixed support, the adjustable horizontal support including a support member configured to engage the wall or the fixed support for leveling the modular connector system;
wherein:
each of the at least one horizontal arms including a first threaded connection point;
the adjustable building material clamp or the adjustable horizontal support including a second threaded connection point affixed thereto;
wherein, the adjustable building material clamp or the adjustable horizontal support is configured to be removably connected to one of the at least one horizontal arms by threadedly engaging the second threaded connection point affixed to the adjustable building material clamp or the adjustable horizontal support onto the first threaded connection point on the horizontal arm; and
wherein the building material members are the vertical piping, the horizontal piping, or the prefab assemblies, where the modular connector system is designed and configured for setting the vertical piping, the horizontal piping, or the prefab assemblies in place prior to construction of the wall.

20. A method of building a wall comprising:
providing a modular connector system for setting building material members in place prior to construction of the wall, the modular connector system comprising:
a base plate configured to support the modular connector system;
a vertical riser member affixed to the base plate in a vertical orientation;
at least one horizontal arm, each of the at least one horizontal arm is configured to be adjustably positioned along the vertical riser member;
each of the at least one horizontal arm including a connection member, the connection member is configured to attach to one of the building material members;
setting the building material members in place via the provided modular connector system; and
constructing the wall with the building material members set in place via the provided modular connector system.
